(19) United States
(12) Patent Application Publication
(10) Pub. No.: US 2024/0391348 A1
(43) Pub. Date: Nov. 28, 2024

(54) ALIGNMENT SYSTEM FOR SWAPPABLE VEHICLE BATTERY

(71) Applicant: Caterpillar Underground Mining Pty. Ltd., South Burnie (AU)

(72) Inventors: Andrew J. NICHOLLS, Cuprona (AU); Sriharsha H. NAGARAJA, Upper Burnie (AU); Andrew E. DIECKER, Shorewell Park (AU); Michael J. WOLFERT, Coes Creek (AU)

(73) Assignee: Caterpillar Underground Mining Pty. Ltd., South Burnie (AU)

(21) Appl. No.: 18/324,845

(22) Filed: May 26, 2023

(51) Int. Cl. B60L 53/80; B60L 50/64; H01M 50/209; H01M 50/249; H01M 50/588

(52) U.S. Cl. CPC B60L 53/80; B60L 50/64; H01M 50/209; H01M 50/249; H01M 50/588

(57) ABSTRACT

A system for aligning a removable battery for a vehicle includes a battery enclosure and a battery receptacle formed on the vehicle, the battery receptacle defined by a first sidewall, a second sidewall, and a support structure. The system also includes a first horizontally-extending guide, a second horizontally-extending guide, a first recess configured to guide the battery enclosure with the first horizontally-extending guide, and a second recess configured to guide the battery enclosure with the second horizontally-extending guide.

### TECHNICAL FIELD

This disclosure relates generally to systems for electric vehicles, and more particularly, to systems for placing a swappable battery on an electric vehicle.

### BACKGROUND

Electric vehicles, including machines for mining, earthmoving, or hauling material, are useful for various tasks and utilized in different types of worksites. Electrically-powered vehicles are particularly useful in environments where emissions are regulated or should otherwise be restricted. For example, while it is beneficial to reduce harmful emissions in general, it is especially desirable to limit carbon dioxide and carbon monoxide emissions in enclosed spaces, such as underground mines.

Electrification of vehicles such as mining machines, while beneficial for environmental, safety, and other reasons, introduces significant challenges. For example, batteries tend to be relatively heavy and store less energy, per unit weight, as compared to fossil fuels used to generate power with internal combustion engines. It is also typically less time consuming to fill a fuel tank, e.g., with diesel fuel, as compared to the time needed to charge a battery pack with a similar energy capacity.

Battery capacities, charging rates, and power outputs have generally increased over time, making electrified vehicles more practical. However, batteries for electric vehicles can still become depleted while performing work, causing the vehicles to be taken out of service while batteries are charging. Swappable batteries can increase uptime and productivity by reducing the amount of time a vehicle is out of service. However, swappable batteries are heavy and can be challenging to position and connect to the electric vehicle. Batteries include, for example, electrical connections that involve precise positioning of the battery and/or the use of multiple operators to manually position, adjust, and connect the battery to the vehicle when performing a battery change.

An exemplary mining vehicle is described WO Publication No. 2020/091672 A1 (“the '672 publication”) to Persson et al. The mining vehicle described in the '672 publication includes vertically-oriented guiding elements for a battery compartment. These vertical guide elements are formed on sides of the battery compartment. The vehicle and vertical guide elements of the '672 publication limit options for battery placement and removal by requiring precise vertical movement of the battery. Further, the guide elements of the '672 publication require puck-shaped protrusions on sidewalls of the battery. These protrusions can potentially damage the vertical guide elements themselves or cause damage to the chassis of the vehicle.

The techniques of this disclosure may solve one or more of the problems set forth above and/or other problems in the art. The scope of the current disclosure, however, is defined by the attached claims, and not by the ability to solve any specific problem.

### SUMMARY

In one aspect, a system for aligning a removable battery for a vehicle may include a battery enclosure and a battery receptacle formed on the vehicle, the battery receptacle defined by a first sidewall, a second sidewall, and a support structure. The system may also include a first horizontally-extending guide, a second horizontally-extending guide, a first recess configured to guide the battery enclosure with the first horizontally-extending guide, and a second recess configured to guide the battery enclosure with the second horizontally-extending guide.

In another aspect, an electric vehicle may include a chassis including a first sidewall, a second sidewall, and a support structure that together define at least a portion of a battery receptacle, and a guide that protrudes away from the support structure in a vertical direction, the guide extending in a horizontal direction that is substantially parallel to the first sidewall. The electric vehicle may also include an upper end of the guide configured to adjust an orientation of a battery enclosure when the battery enclosure is lowered onto the support structure.

In yet another aspect, a battery enclosure for connecting a battery to an electric vehicle may include four or more sides defining an interior configured to receive a plurality of battery cells, a bottom side, a guide recess formed in the bottom side and extending substantially parallel to a first side of the four or more sides, and a pair of angled walls defining opposing sides of the guide recess.

### BRIEF DESCRIPTION OF THE DRAWINGS

FIG. 1 is a perspective view illustrating an electric vehicle having a swappable battery alignment system, according to aspects of the disclosure.

FIG. 2 is an enlarged perspective view of the electric vehicle of FIG. 1 with the swappable battery removed.

FIG. 3 is a perspective view of a battery enclosure usable with the vehicle of FIG. 1.

FIG. 4 is a perspective view showing a bottom side of the battery enclosure of FIG. 3.

FIG. 5A is a cross-sectional view showing a battery enclosure that is being guided onto an electric vehicle with an alignment system, according to aspects of the disclosure.

FIG. 5B is a cross-sectional view showing the battery enclosure positioned on the electric vehicle.

FIG. 6 is a schematic cross-sectional view illustrating electrical connectors of the vehicle and battery enclosure, according to aspects of the disclosure.

### DETAILED DESCRIPTION

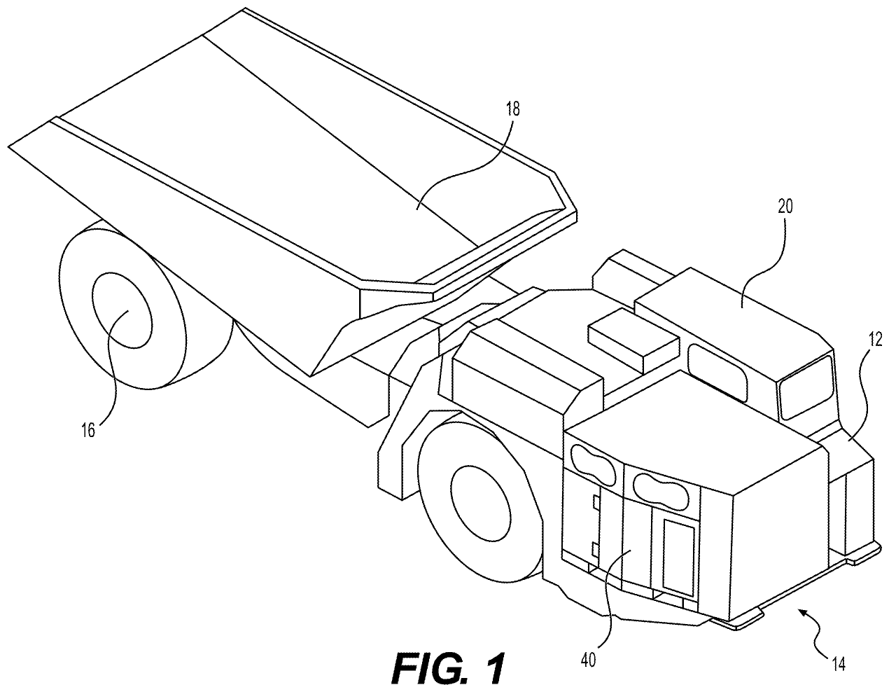

FIG. 1 is a perspective view illustrating an electrically-powered vehicle 12, also referred to herein as an electric vehicle 12, which is capable of operating solely on electric power. As used herein, “vehicle” is intended to encompass machines that perform work, including hauling machines, earthmoving machines, and other machines that perform tasks (e.g., with one or more implements), as well as vehicles for transportation. In some aspects, vehicle 12 may have a battery assembly with a battery enclosure 40 that houses or includes a plurality of battery modules connected in series and/or in parallel to provide energy for locomotion, operating implements, powering control systems, etc. The battery modules within battery enclosure 40 may include one or more battery cells, in a known manner. Vehicle 12 may include an alignment system 14 for placing battery enclosure 40 on vehicle 12, a ground-engaging traction device 16, a bed 18, and a cabin 20.

Traction device 16 may include wheels, as shown in FIG. 1, and/or tracks or other mechanisms to facilitate movement and steering of vehicle 12. Ground-engaging traction device 16 may be driven by one or more electric motors, transmission systems, and other components of vehicle 12. As shown in FIG. 1, vehicle 12 may be a haul truck that includes the bed 18. Bed 18 may be movable between a raised dump position (not shown) and a lowered hauling position. In vehicles 12 other than haul trucks, bed 18 may be replaced with an implement that performs work such as carthmoving, drilling, lifting, etc., or vehicle 12 may be provided without a bed and without an implement. Cabin 20 may include an enclosed space of vehicle 12 containing control devices, such as pedals, joysticks, steering wheels, levers, buttons, etc., for operating machine 12. If desired, vehicle 12 may be capable of partially-autonomous or fully-autonomous operation and cabin 20 may be omitted.

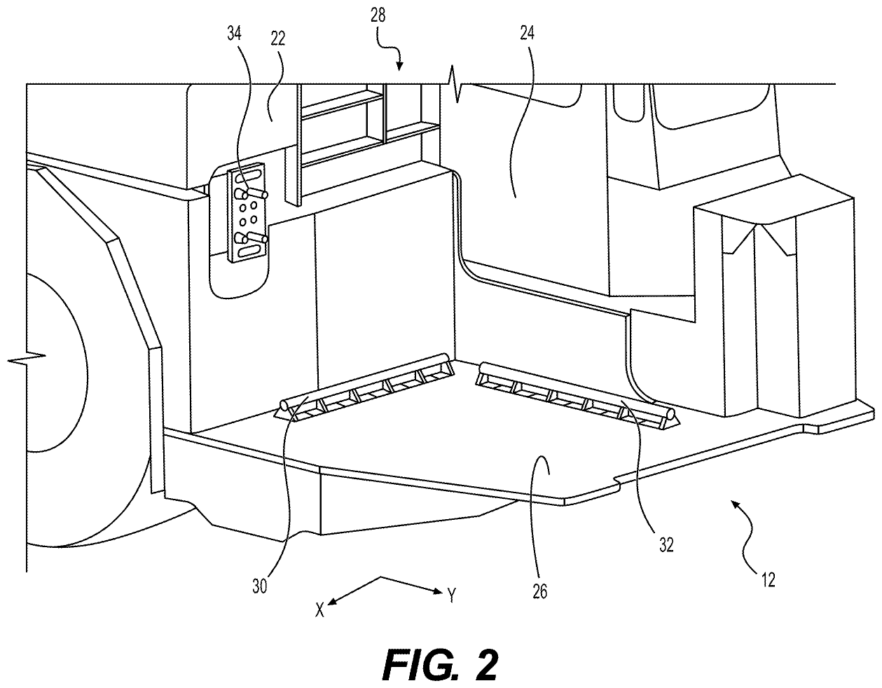

Alignment system 14 may include one or more components of vehicle 12 (e.g., components on a chassis of vehicle 12 or included as part of the chassis of vehicle 12) and one or more components of battery enclosure 40 that together guide and align battery enclosure 40 on vehicle 12. FIG. 2 illustrates a battery-receiving portion (e.g., battery receptacle 28, described below) of vehicle 12 with battery enclosure 40 removed, showing components of system 14 located on the chassis of vehicle 12. In the exemplary configuration of system 14 shown in FIG. 2, system 14 includes a battery receptacle 28 that is partially or entirely defined by a first sidewall 22, a second sidewall 24, and a floor or support structure 26. System 14 may include a first guide 30 and a second guide 32, both guides 30 and 32 protruding upward from a generally flat surface of support structure 26.

First sidewall 22 may be formed with the chassis of vehicle 12 to define a rear side of battery receptacle 28. Second sidewall 24 may also be formed with the chassis of vehicle 12, such as cabin 20, to define a lateral side of battery receptacle 28.

A vehicle connector 34 may be formed in first sidewall 22 and may be configured to connect batteries within battery enclosure 40 to electrical systems of vehicle 12 including power conversion devices, electrical motors, implement systems (e.g., systems for raising and lowering bed 18), etc. Vehicle connector 34 may instead be located on second sidewall 24, instead of the connector 34 on first sidewall 22 or as an additional electrical connector.

Battery receptacle 28 may have a generally rectangular shape when viewed from above, with first sidewall 22 extending in a first horizontal direction “X” and second sidewall 24 extending in a second horizontal direction “Y,” as shown in FIG. 2. The two horizontal directions X and Y, may be approximately perpendicular to each other, forming an approximately 90 degree angle. Receptacle 28 may be open on two sides, the two open sides of receptacle 28 being located opposite sidewalls 22 and 24. These open sides may extend above edges of support structure 26 (e.g., a side edge opposite sidewall 24 and a front edge opposite of sidewall 22). While receptacle 28 is shown in FIG. 2 with two open sides, as understood, receptacle 28 may be open on exactly one side (e.g., by including a front wall or a side wall that extends upwards from structure 26 so as to overlap a portion or entirety of the corresponding wall of enclosure 40 when enclosure 40 is placed on vehicle 12). If desired, support structure 26 may include a raised structure, such as a lip, that extends along a portion or an entirety of the side edge and front edge that respectively oppose sidewalls 22 and 24.

First guide 30 may extend horizontally (e.g., along or parallel to direction X in FIG. 2), and generally parallel to first sidewall 22. Second guide 32 may extend horizontally (e.g., along or parallel to direction Y in FIG. 2), and generally parallel to second sidewall 24. While two guides 30 and 32 are shown in FIG. 2, other configurations may include additional guides or a single guide, including guides adjacent to the side and/or front edges of support structure 26. Additional guides may be parallel to first guide 30 or second guide 32. Additionally or alternatively, one or more additional guides may extend obliquely with respect to both guides 30 and 32. Also, other orientations of first guide 30 and second guide 32 are possible. For example, first guide 30 and second guide 32 may extend obliquely with respect to each other.

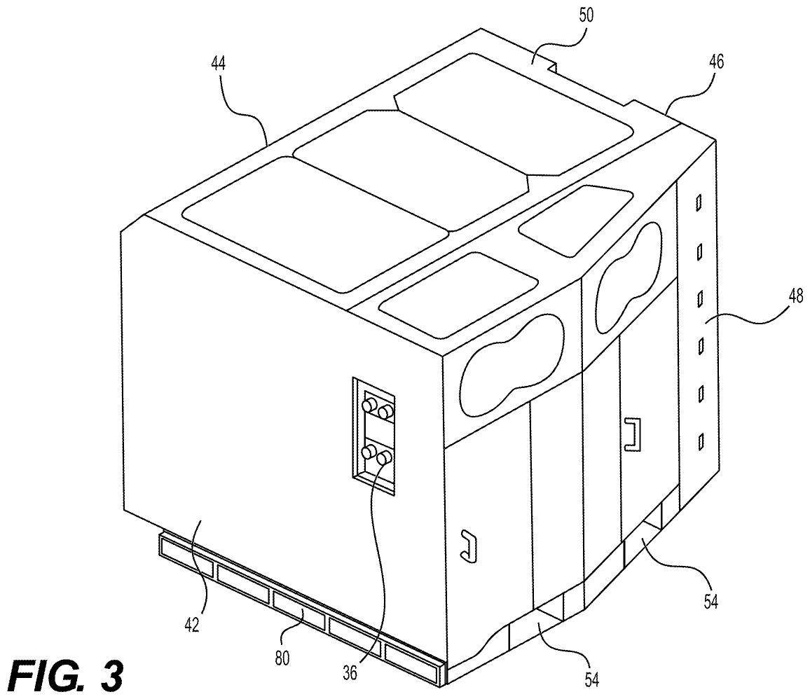

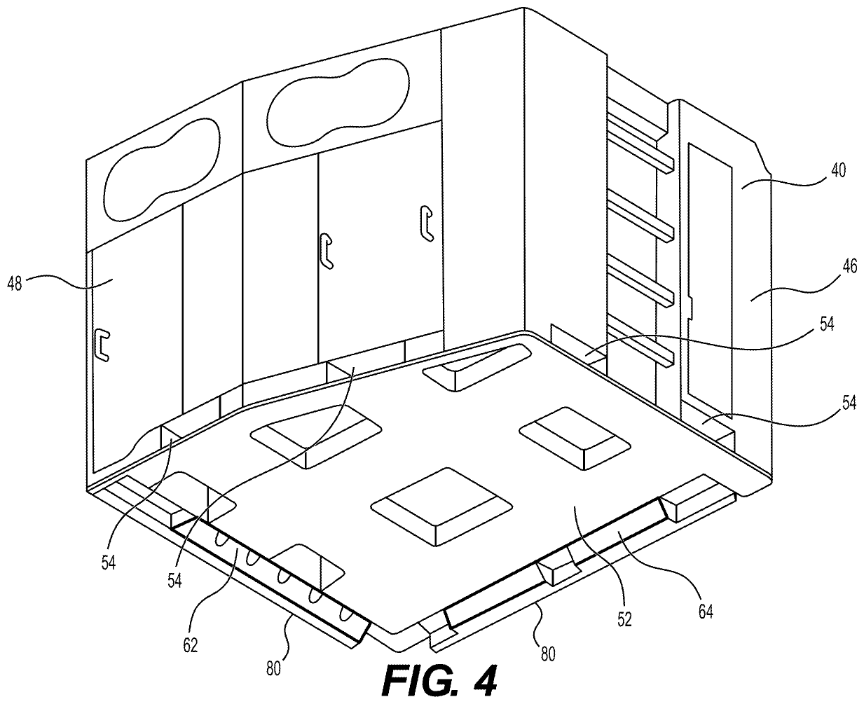

FIGS. 3 and 4 are perspective views showing battery enclosure 40, according to an exemplary configuration. Battery enclosure 40 may form a housing containing battery cells, the cells being electrically connected to form one or more battery modules (not shown). When viewed from above or below, battery enclosure 40 may have an approximately trapezoidal shape (FIGS. 3 and 4), a generally rectangular shape, or a generally square shape. Battery enclosure 40 may have four sides formed by vertical walls, including a rear side 42, a first lateral side 44, a front side 46, and a second lateral side 48. A top side 50 may cover upper ends of the battery modules, while a bottom side 52 may support battery modules, racks for the battery modules, cooling system components, and other devices connected to and/or contained within enclosure 40.

Support structure 26 may be a flat surface, as described above, that forms a flat deck. However, support structure 26 may also include structures that extend below the flat surface of structure 26, such as flanges, ribs, fasteners, etc. In particular, support structure 26 may include one or more mechanisms (not shown) to secure and retain battery enclosure 40 in place. Additionally or alternatively, one or more mechanisms for securing and retaining battery enclosure 40 may be located on sidewall 22 and/or sidewall 24. If desired, support structure 26 may include one or more openings to reduce the weight of structure 26 and/or allow access to components below support structure 26.

Battery enclosure 40 may be defined by an external housing. The housing may form an enclosure with openings for ventilation. For example, enclosure 40 may include one or more fans, access panels to facilitate maintenance or repair, and a battery connector 36. Battery connector 36 may be electrically connected with the battery module or modules within battery enclosure 40. Battery connector 36 may allow energy transfer from batteries within battery enclosure 40 to electrical systems of vehicle 12 via vehicle connector 34.

Alignment system 14 may include features located on battery enclosure 40 that assist with placement of battery enclosure 40 in battery receptacle 28. For example, battery enclosure 40 may include a bumper 80 formed at a bottom end of rear side 42 and protruding outwardly from a periphery of enclosure 40 defined by walls 42, 44, 46, and 48. A second bumper 80 may also be formed at the bottom end of first lateral side 44 (only one bumper 80, on rear side 42, being visible in FIG. 3). Bumper 80 may be formed of a durable, resilient material (e.g., rubber) that protrudes from the surface of rear side 42. A first bumper 80 that protrudes from rear side 42 may be designed for occasional contact with first sidewall 22, while a second bumper 80 that protrudes from first lateral side 44 may be designed for occasional contact with second sidewall 24

As shown in FIG. 4, battery enclosure 40 may include a first guide recess 62 formed in bottom side 52, and a second guide recess 64 also formed in bottom side 52. Battery enclosure 40 may also include structures to facilitate lifting and placement of battery enclosure 40, such as lifting receptacles 54 that are formed as fork-receiving openings in one or more sides of battery enclosure 40. In the example illustrated in FIG. 4, lifting receptacles 54 are formed as pairs of openings, a first pair of openings being at the bottom of second lateral side 48 and a second pair of openings being located the bottom of front side 46. These lifting receptacles 54 may enable a forklift to lift, position, and lower battery enclosure 40. Battery enclosure 40 may include other lifting and placement structures, instead of or in addition to lifting receptacles 54. For example, one or more hoist rings, rails, etc., may be connected to top side 50, second lateral side 48, and/or front side 46 to allow battery enclosure 40 to be raised with a crane or other lifting machine.

Recesses 62 and 64 may be parts of system 14 and may be sized for sliding engagement with first guide 30 and second guide 32 when battery enclosure 40 is lowered within battery receptacle 28, as described below. First recess 62 and second recess 64 may extend in directions that generally align with first guide 30 and second guide 32 (e.g., the X and Y direction shown in FIG. 2). Therefore, when first guide 30 and second guide 32 extend substantially perpendicular to each other, first recess 62 and second recess 64 may extend substantially perpendicular to each other. Similarly, when first guide 30 and second guide 32 extend obliquely with respect to each other, first recess 62 and second recess 64 extend obliquely to each other.

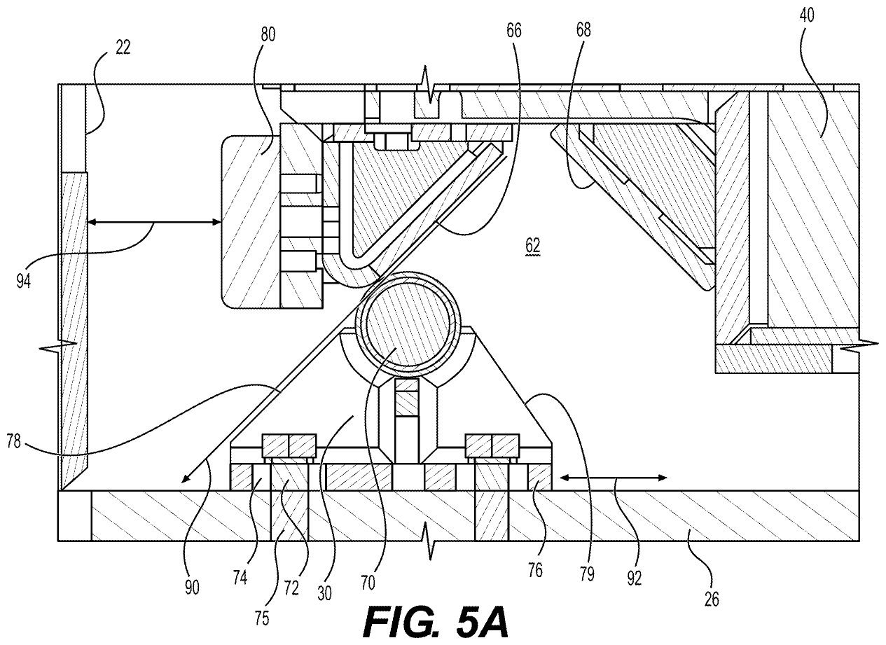

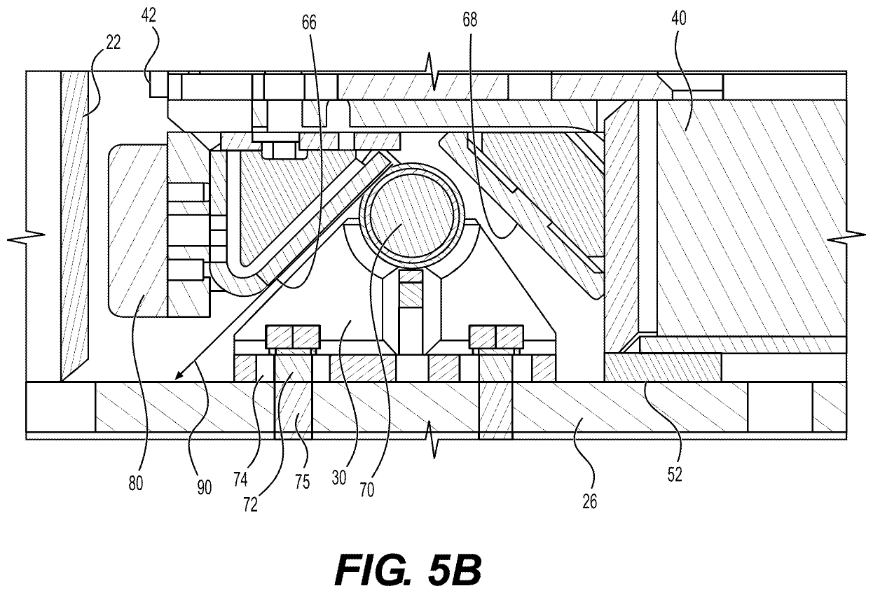

FIG. 5A is a cross-sectional view showing initial engagement between first guide 30 and first recess 62. FIG. 5B is a cross-sectional view showing a final resting position following engagement between first guide 30 and first recess 62, and after enclosure 40 has been positioned with guide 30. While second guide 32 and second recess 64 are not shown in FIGS. 5A and 5B, as understood, the structures, movements, and positioning window described for FIGS. 5A and 5B are equally applicable to second guide 32 and second recess 64, with second recess 64 taking the place of first recess 62 and second sidewall 24 taking the place of first sidewall 22.

As shown in FIG. 5A, first guide recess 62 may be defined by a pair of opposing sides formed by a first inclined wall 66 and a second inclined wall 68. Walls 66 and 68 may form a triangularly-shaped opening or trench that corresponds to recess 62. However, other shapes are contemplated for recess 62, including a rectangular shape, or other shapes defined when one or both of walls 66 and 68 are rounded or otherwise curved, as described below.

Bumper 80 may connect to a side of rear side 42 that is intended to face first sidewall 22 when battery enclosure 40 is placed on vehicle 12. Bumper 80 may extend in approximately the same direction as first guide recess 62, and on a side of enclosure 40 closest to recess 62. A second bumper 80 may extend in approximately the same direction as second guide recess 64, and on a side of enclosure 40 closes to recess 64. As shown in FIG. 5A, bumper 80 may overlap recess 62 (or recess 64), as bumper 80 is placed on a support structure behind wall 66.

First guide 30 may include a bottom end connected to support structure 26 and a top end that is received within first guide recess 62. The bottom end of guide 30 may be formed by a longitudinally-extending plate 76. Longitudinally-extending plate 76 may include a series of through-holes 72 configured to receive removable fasteners 75 (e.g., bolts). The through-holes 72 may extend to form slots 74, if desired. These slots 74 may have a width that is smaller than a head of fasteners 75 in a direction that is perpendicular to a direction 92 (described below), to facilitate secure positioning of plate 76.

The top end of guide 30 may include a rounded surface, such as a rail 70. Rail 70 may be fixedly connected to guide 30, as shown, or may be monolithically formed with guide 30. In particular, both plate 76 and rail 70 may be formed as a unitary structure, providing an entirety of guide 30 with a unitary structure that is connected via fasteners 72. In some embodiments, fasteners 75 and slots 74 may be omitted, and guide 30 may be permanently connected to support structure 26 (e.g., connected by welding or formed as a unitary structure). Guide 32 may be formed in the same manner. Further, while a cylindrical rail having a circular cross-section is shown in FIGS. 5A and 5B, other shapes may be used. For example, rail 70 may be formed with a semi-circular shape, a rectangular shape, etc. Regardless of the shape of rail 70, recesses 62 and 64 may have shapes that are complementary to the shapes of rails 70. For example, complementary shapes may mate with each other and/or enable a surface of rail 70 to slide along a surface of recess 62 or 64, regardless of whether rail 70 includes a curved surface. In the illustrated embodiment, the rounded surface of rail 70 may facilitate sliding of battery enclosure 40 along first inclined wall 66 or second inclined wall 68. If desired, one or more of rail 70, wall 66, and wall 68 may be provided with a durable coating to reduce wear and/or provide a desired level of friction. Further, if desired, recesses 62 and 64 may instead be formed on vehicle 12, while guides 30 and 32 protrude downward from enclosure 40.

FIG. 5A shows battery enclosure 40 positioned at a maximum distance from first sidewall 22 while engaging rail 70 of first guide 30. This maximum distance may correspond to a full length of positioning window 94, positioning window 94 representing a range of possible distances between battery enclosure 40 and first sidewall 22 at which first inclined wall 66 or second inclined wall 68 can contact rail 70. Positioning window 94 may be a range of, for example, from 0 inches (0 centimeters) (e.g., when bumper 80 contacts first sidewall 22) to about 3 inches (about 7.6 centimeters). In the example shown in FIG. 5A, positioning window 94 is measured from the part of enclosure 40 that is closest to wall 22.

Slots 74 may be sized to receive removable fasteners 75 such that, when fasteners 75 are tightened, first guide 30 is rigidly secured to support structure 26. When removable fasteners 75 are loosened, some movement of first guide 30 may be enabled by slots 74. For example, first guide 30 may be adjustable towards or away from first sidewall 22 along a direction 92 to facilitate fine positioning of first guide 30. The presence of two guides 30 and 32 with respective pairs of plates 76 and a corresponding series of slots 74 may therefore enable alignment of vehicle connector 34 and battery connector 36 along two directions.

FIG. 5B shows relative positions of battery enclosure 40 and first guide 30 once enclosure 40 has slid along a direction 90 and reached a resting position. When in this resting position, a gap may be formed between second inclined wall 68 and rail 70 (as shown in FIG. 5B), or between first inclined wall 66 and rail 70. This may allow bottom side 52 to contact and rest on support structure 26 before rail 70 reaches a full depth of first guide recess 62. Once in this resting position, battery enclosure 40 may be secured (e.g., fastened, locked, or otherwise connected to vehicle 12 in a manner that resists relative movement of enclosure 40 and vehicle 12) and retained in place to the chassis of vehicle 12.

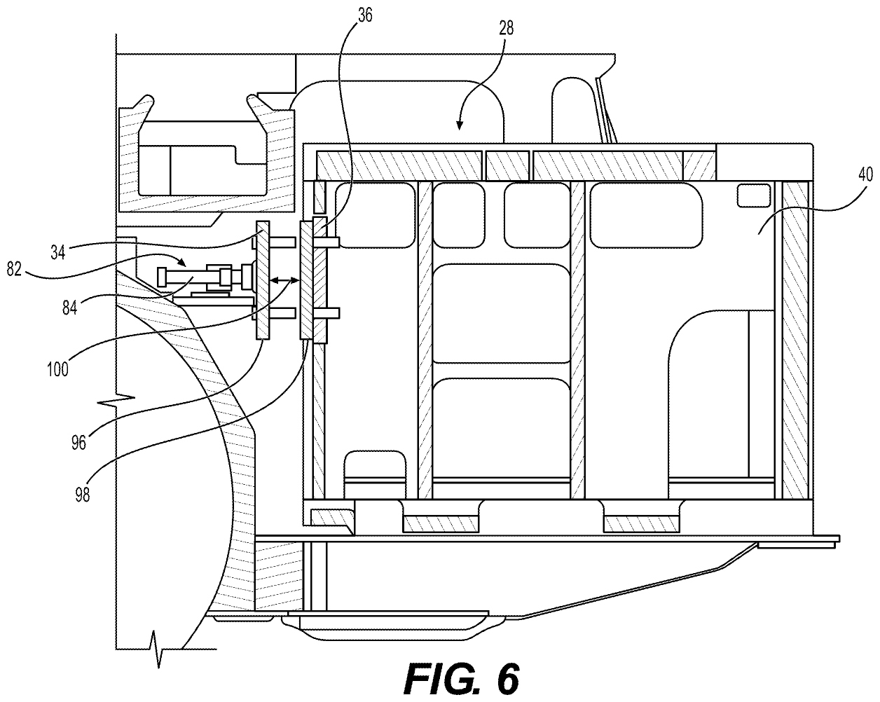

FIG. 6 is a cross-sectional view showing a hollow interior of enclosure 40 that receives a plurality of battery cells (batteries and battery cells not shown) and a mechanism for electrically connecting vehicle 12 with batteries within battery enclosure 40 with enclosure 40 positioned on support structure 26. For example, battery enclosure 40 may be secured within positioning window 94 (FIG. 5A) with battery connector 36 facing vehicle connector 34. In the example shown in FIG. 6, vehicle connector 34 includes a plurality of protruding electrical connectors, while battery connector 36 includes a corresponding number of recesses or receptacles for receiving these protruding connectors. However, protruding connectors may instead be on battery connector 36, or both vehicle connector 34 and battery connector 36 may include protruding connectors.

Vehicle connector 34 may be controllably movable (e.g., via one or more input devices within cabin 20) between a retracted position 96 and an extended positon 98. An actuator 82 of vehicle 12 may be connected to vehicle connector 34 in a manner that allows actuator 82 to extend and retract vehicle connector 34 within a connector window 100. For example, actuator 82 may be configured to move connector 34 between a fully-retracted position 96 and a fully-extended position 98. Window 100 may correspond to the maximum travel, or the distance between positions 96 and 98. Thus, connector window 100 may correspond to the maximum distance at which enclosure 40 can be placed while still being capable of electrical connection to vehicle 12. Actuator 82 may be a linear actuator such as an electro-mechanical actuator, a hydraulic actuator, or a pneumatic actuator. When enclosure 40 is positioned with alignment system 14, guides 30 and 32 may facilitate placement of battery connector 36 within connector window 100.

While in retracted position 96, an entirety of vehicle connector 34 may be spaced away from battery receptacle 28 to prevent battery enclosure 40 from physically contacting vehicle connector 34 during placement of battery enclosure 40. When in extended position 98, electrical connectors of vehicle connector 34 may contact electrical receptacles of battery connector 36. While actuator 82 is shown within vehicle 12 for extending and retracting vehicle connector 34 towards and away from battery connector 36, if desired, vehicle connector 34 may be permanently recessed within vehicle 12 and battery connector 36 may be connected to an actuator within battery enclosure 40 that is configured to drive battery connector 36 towards vehicle connector 34.

### Industrial Applicability

System 14 may be incorporated in any vehicle 12 that is configured for use with a swappable battery, including fully-electric vehicles and partially-electric vehicles (e.g., vehicles having an internal combustion engine for generating additional or backup power). System 14 may be used in vehicles configured for hauling material, and in particular, in haul vehicles for use in enclosed spaces, such as mines. System 14 may enable battery swapping within a mine, without the need to propel vehicle 12 to a specific location (e.g., outside of the mine or other worksite) to charge the battery or swap the battery using specialized equipment.

During operation of vehicle 12 and system 14, vehicle 12 may be propelled and/or may perform work using electrical power stored in batteries contained within battery enclosure 40. During the operation of vehicle 12, batteries within battery enclosure 40 will gradually deplete and it will be necessary to replace a current battery enclosure 40 with a battery enclosure 40 with batteries having a higher level of charge.

A battery swapping process may begin when batteries of a battery enclosure 40 present on vehicle 12 become depleted, or at other times when battery replacement is desired. The battery swapping process may begin by removing this battery enclosure 40 from vehicle 12. This may be performed by first activating actuator 82 to retract vehicle connector 34 from extended position 98 to retracted position 96 (FIG. 6), and unlocking or otherwise removing any mechanisms that are securing enclosure 40 within receptacle 28. Subsequently, enclosure 40 may be lifted with a forklift, crane, or other device capable of raising heavy loads.

A second battery enclosure 40 containing charged batteries may then be lifted and positioned generally above support structure 26 and partially within battery receptacle 28. In some embodiments, the second battery enclosure 40 may be lifted from a ground surface, or from a platform. In other embodiments, the second battery enclosure 40 may be raised above support structure 26 such that battery enclosure 40 is moved horizontally and lowered, without being lifted. Battery enclosure 40 may be generally aligned above support structure 26 such that first guide recess 62 at least partially overlaps first guide 30 and second guide recess 64 at least partially overlaps second guide 32, in a vertical direction. This may be accomplished by locating battery enclosure 40 within positioning window 94 from first sidewall 22 and within a corresponding positioning window 94 from second sidewall 24, as represented in FIG. 5A.

Battery enclosure 40, once within positioning window(s) 94, may be lowered until first inclined wall 66 or second inclined wall 68 comes into contact with rail 70 of first guide 30, as shown in FIG. 5A. Corresponding inclined walls that define second recess 64 may come into contact with rail 70 of second guide 32 at approximately the same time. Once an inclined wall contacts rail 70, battery enclosure 40 may slide along direction 90 until reaching a final resting position represented by FIG. 5B.

During positioning of a battery assembly including battery enclosure 40, batteries, and supporting components, system 14 may facilitate alignment along multiple directions. This alignment may enable connection of vehicle connector 34 and battery connector 36. For example, first guide 30 and first guide recess 62 may correct misalignments in a first direction, while second guide 32 and second guide recess 64 correct misalignments in a second direction. In the event that battery enclosure 40 is not positioned as desired once bottom side 52 rests on support structure 26 (e.g., during initial installation of battery enclosure 40 before a battery swap has been performed), battery enclosure 40 may be removed to facilitate adjustments of guide 30 and/or guide 32 via slots 74. With battery enclosure 40 removed, one or both of first guide 30 and second guide 32 may be adjusted by loosening and removing fasteners 75, moving the guide along support structure 26 to an adjusted positioning, and re-inserting and tightening fasteners 75.

Vehicle 12 and system 14 may ensure proper placement of a battery assembly secured via battery enclosure 40 for powering vehicle 12, without the need for manual adjustment of battery enclosure 40 each time battery enclosure 40 is installed. System 14 may facilitate alignment of two electrical connectors, such as vehicle connector 34 and battery connector 36 within about 0.8 inch (20 mm) of each other, within 0.4 inch (10 mm) of each other, or advantageously, within 0.2 inch (6 mm) of each other. System 14 may also align mounting points on vehicle 12 and battery enclosure 40, within about the same distance. System 14 may reduce the amount of time needed to perform a battery swap process, ensuring that battery enclosure 40 is correctly positioned and aligned, repeatedly, reliably, and efficiently. System 14 may also reduce skill requirements for the operator (e.g., an operator of a forklift or crane) manually placing battery enclosure 40 on vehicle 12, enabling relatively inexperienced operators to perform a battery swap.

What is claimed is:

1. A system for aligning a removable battery for a vehicle, the system comprising:
a battery enclosure;
a battery receptacle formed on the vehicle, the battery receptacle defined by:
a first sidewall;
a second sidewall; and
a support structure;
a first horizontally-extending guide;
a second horizontally-extending guide;
a first recess configured to guide the battery enclosure with the first horizontally-extending guide; and
a second recess configured to guide the battery enclosure with the second horizontally-extending guide.

2. The system of claim 1, wherein the first and second horizontally-extending guides are located on the vehicle and the first and second recesses are located on the battery enclosure.

3. The system of claim 2, wherein the first horizontally-extending guide is secured generally parallel to the first sidewall and the second horizontally-extending guide is secured generally parallel to the second sidewall.

4. The system of claim 3, wherein the first and second recesses extend within a bottom wall of the battery enclosure.

5. The system of claim 1, wherein the first and second horizontally-extending guides include rails that are configured to slide within the first and second recesses, respectively, when the battery enclosure is placed in the battery receptacle.

6. The system of claim 1, wherein the first and second recesses are defined by respective pairs of angled walls.

7. The system of claim 1, further comprising a bumper protruding from a first side of the battery enclosure.

8. The system of claim 1, further comprising:
a first electrical connector on the vehicle;
a second electrical connector supported on the battery enclosure; and
an actuator configured to move the first electrical connector towards the second electrical connector when the battery enclosure is positioned in the battery receptacle.

9. The system of claim 8, wherein the first horizontally-extending guide and the second horizontally-extending guide are configured to place the second electrical connector within a connector window that is measured from a fully-retracted position of the first electrical connector and a fully-extended position of the first electrical connector.

10. An electric vehicle, comprising:
a chassis including a first sidewall, a second sidewall, and a support structure that together define at least a portion of a battery receptacle;
a guide that protrudes away from the support structure in a vertical direction, the guide extending in a horizontal direction that is substantially parallel to the first sidewall; and
an upper end of the guide configured to adjust an orientation of a battery enclosure when the battery enclosure is lowered onto the support structure.

11. The electric vehicle of claim 10, further comprising an electrical connector in the first sidewall, the electrical connector being movable towards the battery receptacle.

12. The electric vehicle of claim 10, wherein the guide is a first guide and the upper end of the guide includes a first rail, the electric vehicle further including a second guide with a second rail

13. The electric vehicle of claim 12, wherein the second rail extends approximately perpendicular to the first rail.

14. The electric vehicle of claim 10, wherein the guide is secured to the support structure with one or more fasteners, a position of the guide being adjustable by changing a distance between the first sidewall and the guide with a slot formed in the guide.

15. The electric vehicle of claim 10, wherein the electric vehicle is a hauling machine.

16. A battery enclosure for connecting a battery to an electric vehicle, the battery enclosure comprising:
four or more sides defining an interior configured to receive a plurality of battery cells;
a bottom side;
a guide recess formed in the bottom side and extending substantially parallel to a first side of the four or more sides; and
a pair of angled walls defining opposing sides of the guide recess.

17. The battery enclosure of claim 16, further comprising an additional guide recess formed in the bottom side and extending substantially parallel to a second side of the four or more sides.

18. The battery enclosure of claim 17, wherein the guide recess and the additional guide recess extend in respective directions that are approximately perpendicular to each other.

19. The battery enclosure of claim 16, further comprising an electrical connector formed in the first side.

20. The battery enclosure of claim 16, further comprising a bumper protruding outwardly with respect to a periphery of the battery enclosure defined by the four or more sides.
